(19) United States
(12) Patent Application Publication
(10) Pub. No.: US 2026/0089069 A1
(43) Pub. Date: Mar. 26, 2026

(54) DETERMINING PARAMETERS FOR MULTIPLE MODELS FOR WIRELESS COMMUNICATION SYSTEMS

(71) Applicant: Lenovo (Singapore) Pte. Ltd., Singapore (SG)

(72) Inventors: Vahid Pourahmadi, München (DE); Ahmed Hindy, Aurora, IL (US); Venkata Srinivas Kothapalli, Chicago, IL (US); Vijay Nangia, Woodridge, IL (US)

(21) Appl. No.: 19/112,855

(22) PCT Filed: Sep. 28, 2023
(86) PCT No.: PCT/IB2023/059715

§ 371 Date: Mar. 18, 2025

Related U.S. Application Data
(60) Provisional application No. 63/410,897, filed on Sep. 28, 2022.

(51) Int. Cl. H04L 41/16; H04B 7/06; H04W 24/02

(52) U.S. Cl. CPC H04L 41/16; H04W 24/02; H04B 7/0626

(57) ABSTRACT

Apparatuses, methods, and systems are disclosed for determining parameters for multiple models for wireless communication systems. One method (600) includes determining (602), at a first device, using a first set of information, a set of parameters including first information corresponding to a first model and a second model. The method (600) includes transmitting (604), to a second device, a second set of information including second information for the first model or the second model.

### FIELD

The subject matter disclosed herein relates generally to wireless communications and more particularly relates to determining parameters for multiple models for wireless communication systems.

### BACKGROUND

In certain wireless communications systems, models may be used for wireless communication systems. Transmission of data to train such models may use a large amount of resources.

### BRIEF SUMMARY

Methods for determining parameters for multiple models are disclosed. Apparatuses and systems also perform the functions of the methods. One embodiment of a method includes determining, at a first device, using a first set of information, a set of parameters including first information corresponding to a first model and a second model. In some embodiments, the method includes transmitting, to a second device, a second set of information including second information for the first model or the second model.

One apparatus for determining parameters for multiple models includes a processor. In some embodiments, the apparatus includes a memory coupled to the processor, the processor configured to cause the apparatus to: determine, using a first set of information, a set of parameters including first information corresponding to a first model and a second model; and transmit, to a second device, a second set of information including second information for the first model or the second model.

Another embodiment of a method for determining parameters for multiple models includes receiving, at a second device, from a first device, a set of information including first information corresponding to a first model and a second model. In some embodiments, the method includes determining a third model using the first information. In certain embodiments, the method includes generating an output based on the third model and a first set of data.

Another apparatus for determining parameters for multiple models includes a processor. In some embodiments, the apparatus includes a memory coupled to the processor, the processor configured to cause the apparatus to: receive, from a first device, a set of information including first information corresponding to a first model and a second model; determine a third model using the first information; and generate an output based on the third model and a first set of data.

### BRIEF DESCRIPTION OF THE DRAWINGS

A more particular description of the embodiments briefly described above will be rendered by reference to specific embodiments that are illustrated in the appended drawings. Understanding that these drawings depict only some embodiments and are not therefore to be considered to be limiting of scope, the embodiments will be described and explained with additional specificity and detail through the use of the accompanying drawings, in which:

FIG. 1 is a schematic block diagram illustrating one embodiment of a wireless communication system for determining parameters for multiple models;

FIG. 2 is a schematic block diagram illustrating one embodiment of an apparatus that may be used for determining parameters for multiple models;

FIG. 3 is a schematic block diagram illustrating one embodiment of an apparatus that may be used for determining parameters for multiple models;

FIG. 4 is a schematic block diagram illustrating one embodiment of a wireless network;

FIG. 5 is a schematic block diagram illustrating one embodiment of a system using a two-sided model;

FIG. 6 is a flow chart diagram illustrating one embodiment of a method for determining parameters for multiple models; and

FIG. 7 is a flow chart diagram illustrating another embodiment of a method for determining parameters for multiple models.

### DETAILED DESCRIPTION

As will be appreciated by one skilled in the art, aspects of the embodiments may be embodied as a system, apparatus, method, or program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a program product embodied in one or more computer readable storage devices storing machine readable code, computer readable code, and/or program code, referred hereafter as code. The storage devices may be tangible, non-transitory, and/or non-transmission. The storage devices may not embody signals. In a certain embodiment, the storage devices only employ signals for accessing code.

Certain of the functional units described in this specification may be labeled as modules, in order to more particularly emphasize their implementation independence. For example, a module may be implemented as a hardware circuit comprising custom very-large-scale integration (“VLSI”) circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in code and/or software for execution by various types of processors. An identified module of code may, for instance, include one or more physical or logical blocks of executable code which may, for instance, be organized as an object, procedure, or function. Nevertheless, the executables of an identified module need not be physically located together, but may include disparate instructions stored in different locations which, when joined logically together, include the module and achieve the stated purpose for the module.

Indeed, a module of code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different computer readable storage devices. Where a module or portions of a module are implemented in software, the software portions are stored on one or more computer readable storage devices.

Any combination of one or more computer readable medium may be utilized. The computer readable medium may be a computer readable storage medium. The computer readable storage medium may be a storage device storing the code. The storage device may be, for example, but not limited to, an electronic, magnetic, optical, electromagnetic, infrared, holographic, micromechanical, or semiconductor system, apparatus, or device, or any suitable combination of the foregoing.

More specific examples (a non-exhaustive list) of the storage device would include the following: an electrical connection having one or more wires, a portable computer diskette, a hard disk, a random access memory (“RAM”), a read-only memory (“ROM”), an erasable programmable read-only memory (“EPROM” or Flash memory), a portable compact disc read-only memory (“CD-ROM”), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Code for carrying out operations for embodiments may be any number of lines and may be written in any combination of one or more programming languages including an object oriented programming language such as Python, Ruby, Java, Smalltalk, C++, or the like, and conventional procedural programming languages, such as the “C” programming language, or the like, and/or machine languages such as assembly languages. The code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (“LAN”) or a wide area network (“WAN”), or the connection may be made to an external computer (for example, through the Internet using an Internet Service Provider).

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to,” unless expressly specified otherwise. An enumerated listing of items does not imply that any or all ofthe items are mutually exclusive, unless expressly specified otherwise. The terms “a,” “an,” and “the” also refer to “one or more” unless expressly specified otherwise.

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

Aspects of the embodiments are described below with reference to schematic flowchart diagrams and/or schematic block diagrams of methods, apparatuses, systems, and program products according to embodiments. It will be understood that each block of the schematic flowchart diagrams and/or schematic block diagrams, and combinations of blocks in the schematic flowchart diagrams and/or schematic block diagrams, can be implemented by code. The code may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the schematic flowchart diagrams and/or schematic block diagrams block or blocks.

The code may also be stored in a storage device that can direct a computer, other programmable data processing apparatus, or other devices to function in a particular manner, such that the instructions stored in the storage device produce an article of manufacture including instructions which implement the function/act specified in the schematic flowchart diagrams and/or schematic block diagrams block or blocks.

The code may also be loaded onto a computer, other programmable data processing apparatus, or other devices to cause a series of operational steps to be performed on the computer, other programmable apparatus or other devices to produce a computer implemented process such that the code which execute on the computer or other programmable apparatus provide processes for implementing the functions/acts specified in the flowchart and/or block diagram block or blocks.

The schematic flowchart diagrams and/or schematic block diagrams in the Figures illustrate the architecture, functionality, and operation of possible implementations of apparatuses, systems, methods and program products according to various embodiments. In this regard, each block in the schematic flowchart diagrams and/or schematic block diagrams may represent a module, segment, or portion of code, which includes one or more executable instructions of the code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and code.

The description of elements in each figure may refer to elements of proceeding figures. Like numbers refer to like elements in all figures, including alternate embodiments of like elements.

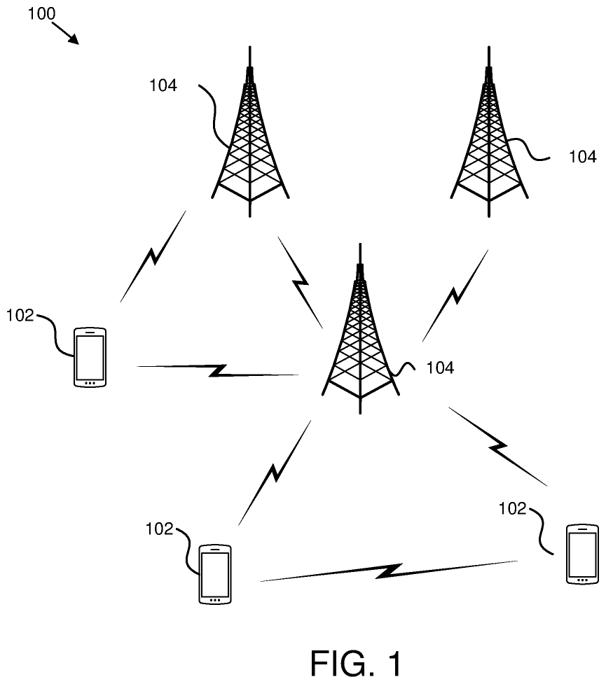

FIG. 1 depicts an embodiment of a wireless communication system 100 for determining parameters for multiple models. In one embodiment, the wireless communication system 100 includes remote units 102 and network units 104. Even though a specific number of remote units 102 and network units 104 are depicted in FIG. 1, one of skill in the art will recognize that any number of remote units 102 and network units 104 may be included in the wireless communication system 100.

In one embodiment, the remote units 102 may include computing devices, such as desktop computers, laptop computers, personal digital assistants (“PDAs”), tablet computers, smart phones, smart televisions (e.g., televisions connected to the Internet), set-top boxes, game consoles, security systems (including security cameras), vehicle on-board computers, network devices (e.g., routers, switches, modems), aerial vehicles, drones, or the like. In some embodiments, the remote units 102 include wearable devices, such as smart watches, fitness bands, optical head-mounted displays, or the like. Moreover, the remote units 102 may be referred to as subscriber units, mobiles, mobile stations, users, terminals, mobile terminals, fixed terminals, subscriber stations, user equipment (“UE”), user terminals, a device, or by other terminology used in the art. The remote units 102 may communicate directly with one or more of the network units 104 via UL communication signals. In certain embodiments, the remote units 102 may communicate directly with other remote units 102 via sidelink communication.

The network units 104 may be distributed over a geographic region. In certain embodiments, a network unit 104 may also be referred to and/or may include one or more of an access point, an access terminal, a base, a base station, a location server, a core network (“CN”), a radio network entity, a Node-B, an evolved node-B (“eNB”), a 5G node-B (“gNB”), a Home Node-B, a relay node, a device, a core network, an aerial server, a radio access node, an access point (“AP”), new radio (“NR”), a network entity, an access and mobility management function (“AMF”), a unified data management (“UDM”), a unified data repository (“UDR”), a UDM/UDR, a policy control function (“PCF”), a radio access network (“RAN”), a network slice selection function (“NSSF”), an operations, administration, and management (“OAM”), a session management function (“SMF”), a user plane function (“UPF”), an application function, an authentication server function (“AUSF”), security anchor functionality (“SEAF”), trusted non-3GPP gateway function (“TNGF”), or by any other terminology used in the art. The network units 104 are generally part of a radio access network that includes one or more controllers communicably coupled to one or more corresponding network units 104. The radio access network is generally communicably coupled to one or more core networks, which may be coupled to other networks, like the Internet and public switched telephone networks, among other networks. These and other elements of radio access and core networks are not illustrated but are well known generally by those having ordinary skill in the art.

In one implementation, the wireless communication system 100 is compliant with NR protocols standardized in third generation partnership project (“3GPP”), wherein the network unit 104 transmits using an orthogonal frequency division multiplexing (“OFDM”) modulation scheme on the downlink (“DL”) and the remote units 102 transmit on the uplink (“UL”) using a single-carrier frequency division multiple access (“SC-FDMA”) scheme or an OFDM scheme. More generally, however, the wireless communication system 100 may implement some other open or proprietary communication protocol, for example, WiMAX, institute of electrical and electronics engineers (“IEEE”) 802.11 variants, global system for mobile communications (“GSM”), general packet radio service (“GPRS”), universal mobile telecommunications system (“UMTS”), long term evolution (“LTE”) variants, code division multiple access 2000 (“CDMA2000”), Bluetooth®, ZigBee, Sigfox, among other protocols. The present disclosure is not intended to be limited to the implementation of any particular wireless communication system architecture or protocol.

The network units 104 may serve a number of remote units 102 within a serving area, for example, a cell or a cell sector via a wireless communication link. The network units 104 transmit DL communication signals to serve the remote units 102 in the time, frequency, and/or spatial domain.

In various embodiments, a remote unit 102 and/or a network unit 104 may determine using a first set of information, a set of parameters including first information corresponding to a first model and a second model. In some embodiments, the remote unit 102 and/or a network unit 104 may transmit, to a second device, a second set of information including second information for the first model or the second model. Accordingly, the remote unit 102 and/or the network unit 104 may be used for determining parameters for multiple models.

In certain embodiments, a remote unit 102 and/or a network unit 104 may receive from a first device, a set of information including first information corresponding to a first model and a second model. In some embodiments, the remote unit 102 and/or a network unit 104 may determine a third model using the first information. In certain embodiments, the remote unit 102 and/or a network unit 104 may generate an output based on the third model and a first set of data. Accordingly, the remote unit and/or the network unit 104 may be used for determining parameters for multiple models.

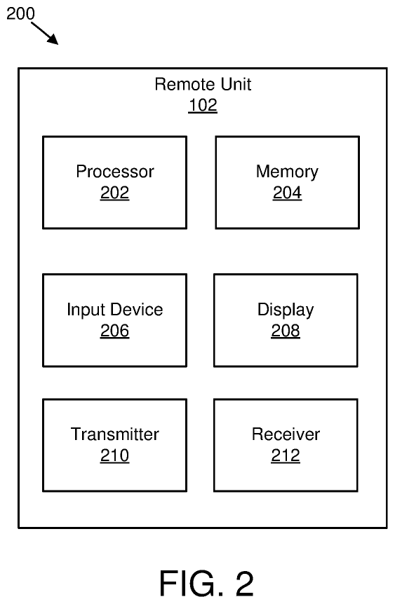

FIG. 2 depicts one embodiment of an apparatus 200 that may be used for determining parameters for multiple models. The apparatus 200 includes one embodiment of the remote unit 102. Furthermore, the remote unit 102 may include a processor 202, a memory 204, an input device 206, a display 208, a transmitter 210, and a receiver 212. In some embodiments, the input device 206 and the display 208 are combined into a single device, such as a touchscreen. In certain embodiments, the remote unit 102 may not include any input device 206 and/or display 208. In various embodiments, the remote unit 102 may include one or more of the processor 202, the memory 204, the transmitter 210, and the receiver 212, and may not include the input device 206 and/or the display 208.

The processor 202, in one embodiment, may include any known controller capable of executing computer-readable instructions and/or capable of performing logical operations. For example, the processor 202 may be a microcontroller, a microprocessor, a central processing unit (“CPU”), a graphics processing unit (“GPU”), an auxiliary processing unit, a field programmable gate array (“FPGA”), or similar programmable controller. In some embodiments, the processor 202 executes instructions stored in the memory 204 to perform the methods and routines described herein. The processor 202 is communicatively coupled to the memory 204, the input device 206, the display 208, the transmitter 210, and the receiver 212.

The memory 204, in one embodiment, is a computer readable storage medium. In some embodiments, the memory 204 includes volatile computer storage media. For example, the memory 204 may include a RAM, including dynamic RAM (“DRAM”), synchronous dynamic RAM (“SDRAM”), and/or static RAM (“SRAM”). In some embodiments, the memory 204 includes non-volatile computer storage media. For example, the memory 204 may include a hard disk drive, a flash memory, or any other suitable non-volatile computer storage device. In some embodiments, the memory 204 includes both volatile and non-volatile computer storage media. In some embodiments, the memory 204 also stores program code and related data, such as an operating system or other controller algorithms operating on the remote unit 102.

The input device 206, in one embodiment, may include any known computer input device including a touch panel, a button, a keyboard, a stylus, a microphone, or the like. In some embodiments, the input device 206 may be integrated with the display 208, for example, as a touchscreen or similar touch-sensitive display. In some embodiments, the input device 206 includes a touchscreen such that text may be input using a virtual keyboard displayed on the touchscreen and/or by handwriting on the touchscreen. In some embodiments, the input device 206 includes two or more different devices, such as a keyboard and a touch panel.

The display 208, in one embodiment, may include any known electronically controllable display or display device. The display 208 may be designed to output visual, audible, and/or haptic signals. In some embodiments, the display 208 includes an electronic display capable of outputting visual data to a user. For example, the display 208 may include, but is not limited to, a liquid crystal display (“LCD”), a light emitting diode (“LED”) display, an organic light emitting diode (“OLED”) display, a projector, or similar display device capable of outputting images, text, or the like to a user. As another, non-limiting, example, the display 208 may include a wearable display such as a smart watch, smart glasses, a heads-up display, or the like. Further, the display 208 may be a component of a smart phone, a personal digital assistant, a television, a table computer, a notebook (laptop) computer, a personal computer, a vehicle dashboard, or the like.

In certain embodiments, the display 208 includes one or more speakers for producing sound. For example, the display 208 may produce an audible alert or notification (e.g., a beep or chime). In some embodiments, the display 208 includes one or more haptic devices for producing vibrations, motion, or other haptic feedback. In some embodiments, all or portions of the display 208 may be integrated with the input device 206. For example, the input device 206 and display 208 may form a touchscreen or similar touch-sensitive display. In other embodiments, the display 208 may be located near the input device 206.

In certain embodiments, the processor 202 is configured to cause the apparatus to: determine, using a first set of information, a set of parameters including first information corresponding to a first model and a second model; and transmit, to a second device, a second set of information including second information for the first model or the second model.

In some embodiments, the processor 202 is configured to cause the apparatus to: receive, from a first device, a set of information including first information corresponding to a first model and a second model; determine a third model using the first information; and generate an output based on the third model and a first set of data.

Although only one transmitter 210 and one receiver 212 are illustrated, the remote unit 102 may have any suitable number of transmitters 210 and receivers 212. The transmitter 210 and the receiver 212 may be any suitable type of transmitters and receivers. In one embodiment, the transmitter 210 and the receiver 212 may be part of a transceiver.

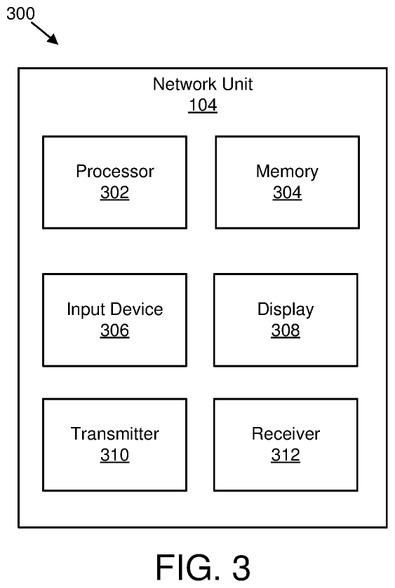

FIG. 3 depicts one embodiment of an apparatus 300 that may be used for determining parameters for multiple models. The apparatus 300 includes one embodiment of the network unit 104. Furthermore, the network unit 104 may include a processor 302, a memory 304, an input device 306, a display 308, a transmitter 310, and a receiver 312. As may be appreciated, the processor 302, the memory 304, the input device 306, the display 308, the transmitter 310, and the receiver 312 may be substantially similar to the processor 202, the memory 204, the input device 206, the display 208, the transmitter 210, and the receiver 212 of the remote unit 102, respectively.

In certain embodiments, the processor 302 is configured to cause the apparatus to: determine, using a first set of information, a set of parameters including first information corresponding to a first model and a second model; and transmit, to a second device, a second set of information including second information for the first model or the second model.

In some embodiments, the processor 302 is configured to cause the apparatus to: receive, from a first device, a set of information including first information corresponding to a first model and a second model; determine a third model using the first information; and generate an output based on the third model and a first set of data.

It should be noted that one or more embodiments described herein may be combined into a single embodiment.

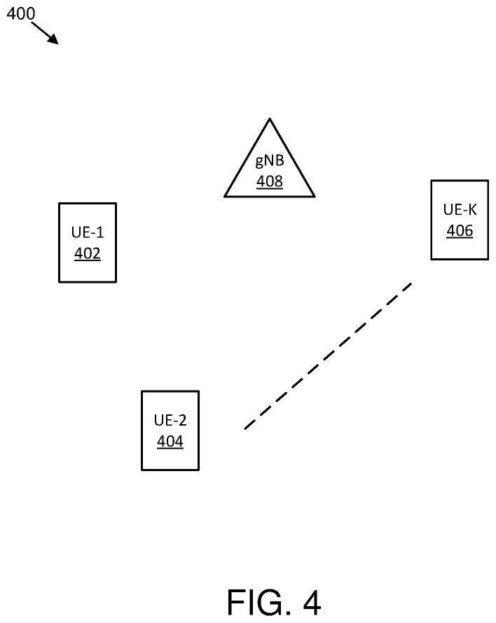

FIG. 4 is a schematic block diagram illustrating one embodiment of a wireless network 400 that includes a first UE 402 (UE-1, UE₁), a second UE 404 (UE-2, UE₂), a Kth UE 406 (UE-K, UE_{K}), and a gNB 408 (Bₗ). B₁ is equipped with M antennas and the K UEs denoted by U₁, U₂, . . . , U_{K} each has N antennas.

$${H}_{l}^{k} ( t )$$

denotes a channel at time t over frequency band l,l∈{1,2, . . . , L}, between B₁ and Uₖ which is a matrix of size N×M with complex entries, i.e.,

$${H}_{l}^{k} ( t )$$

∈ [symbol] .

At the time t and frequency band l, the gNB 408 wants to transmit message

$${x}_{l}^{k} ( t )$$

to user Uₖ where k={1, 2, . . . , K} while it uses

$${w}_{l}^{k} ( t )$$

∈ [symbol]
as the precoding vector. The received signal at Uₖ

$${y}_{l}^{k} ( t ) ,$$

can be written as:

$${y}_{l}^{k} ( t ) = {H}_{l}^{k} ( t ) {w}_{l}^{k} ( t ) {x}_{l}^{k} ( t ) + {n}_{l}^{k} ( t ) ,$$

where

$${n}_{l}^{k} ( t )$$

represents the noise vector at the receiver.

To improve the achievable rate of the link, the gNB 408 selects

$${w}_{l}^{k} ( t )$$

that maximizes the received signal to noise ratio (“SNR”). Several different methods may be used for good selection of

$${w}_{l}^{k} ( t ) ,$$

where most of them rely on having some knowledge about

$${H}_{l}^{k} ( t ) .$$

In some embodiments, the gNB 408 can get knowledge of

$${H}_{l}^{k} ( t )$$

by direct measurement (e.g., in a time domain duplexing (“TDD”) mode and assuming reciprocity of the channel), or indirectly using the information that a UE sends to the gNB 408 (e.g., in a frequency division duplexing (“FDD”) mode). In various embodiments, a large amount of feedback may be needed to send accurate information about

$${H}_{l}^{k} ( t ) .$$

This may be important if there are a large number of antennas or/and large frequency bands.

In certain embodiments herein, only a single time slot is used, but the embodiments may be used with more than a single time slot. Without loss of generality,

$${H}_{l}^{k} ( t )$$

may be denoted using

$${H}_{l}^{k} .$$

Moreover, H^{k} may be defined as a matrix of size N×M×L which includes stacking Hₗ^{k} for all frequency bands, e.g., the entries at H^{k}[n, m, l] is equal to

$${H}_{l}^{k} [ n , m ] .$$

In total, therefore, each UE needs to send information about N×M×L complex numbers to the gNB 408.

In some embodiments, a two-sided model may be used to reduce required feedback information where an encoding part (at the UE) computes a quantized latent representation of the input data, and the decoding part (at the gNB) gets this latent representation and uses that to reconstruct the desired output.

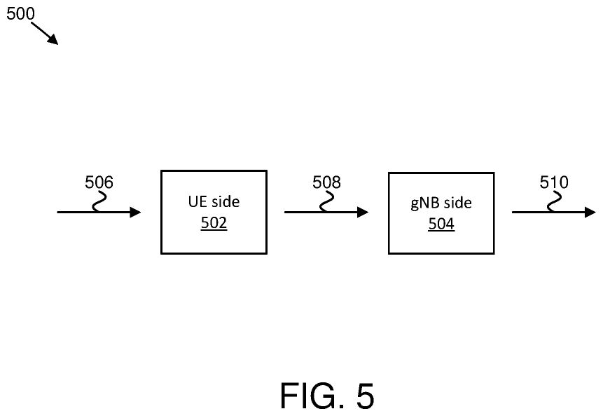

FIG. 5 is a schematic block diagram illustrating one embodiment of a system 500 using a two-sided model with neural network (“NN”)-based models at the UE and gNB sides. The system 500 includes a UE side 502 (Mₑ, encoding model) and a gNB side 504 (M_{d}, decoding model). The UE side 502 receives input data 506 and outputs a latent representation 508. Moreover, the gNB side 504 receives the latent representation 508 and outputs an output 510.

As may be appreciated, there may be several methods to train the NN modules at the UE and gNB sides 502 and 504, including centralized training, simultaneous training, and separate training. Moreover, updating a two-sided model may be carried out centrally on one entity, on different entities but simultaneously, or separately.

In a separate training and/or model update, the NN modules of the UE and the gNB parts are trained in different training sessions (e.g., no forward or backpropagation path between the two parts).

In certain embodiments, there may be different methods to train and/or update a two-sided model in separate training loops. One reason for separate model training is that the UE and the gNB want to use a model that they have designed and optimized themselves and not just run a model that it provided by another vendor.

In some embodiments, separate training of a model may start by training of the model at the UE first and then training of the model at the gNB side (e.g., UE first), or training may start by training at the gNB first and then training of the model at the UE side (e.g., gNB first). It should be noted that there may be other alternatives than the UE first and the gNB first methods.

In the UE first method, the UE uses a channel state information (“CSI”) dataset D={ [symbol] xᵢ, oᵢ [symbol] , i=1, 2, . . . , N} (e.g., where xᵢ is the input CSI and xᵢ and oᵢ is the desired output) collected from the environment to train a local copy of the two sided model, e.g., both the UE part ( [symbol] ) and the NB part ( [symbol] ). The [symbol] part will be used for compressing of x into a latent representation z. In common cases, the UE would have sent [symbol] to the gNB so it can be used as the gNB part (at the gNB) but in case of separate training the gNB wants to use a model trained and optimized by itself.

So, in one embodiment, the UE constructs a dataset Dᵤ that includes samples as [symbol] zᵢ, o [symbol] , where zᵢ is the output of the encoder part, e.g., zᵢ= [symbol] (xᵢ), for xᵢ sampled from the CSI dataset D. This dataset is transmitted to the gNB. The gNB uses dataset Dᵤ to train and/or update the gNB part of the two-sided model, e.g., [symbol] .

In certain embodiments, instead of one UE, several UEs send their data to a central location (e.g., still for the same vendor of UEs) and the training of [symbol] and [symbol] happens using the collective data. This may result in a model with more generalizability as more samples are observed during the training time.

In the gNB first method, the gNB uses the dataset D_{c}, that includes the CSI reports transmitted to the gNB from one or more UEs, e.g., D_{c}={ [symbol] xᵢ, o [symbol] , i=1, 2, N}. Using D_{c}, the gNB trains a local copy of the two-sided model, e.g., both the UE part ( [symbol] ) and the gNB part ( [symbol] ).

The [symbol] part may be used for constructing required CSI information oᵢ from the latent representation, e.g., z, fed back by the UE. In some embodiments, the gNB would have sent [symbol] to the UE so it can be used as the UE part (e.g., at the UE) but for separate training, UEs may use a model trained and optimized by themselves.

So, in one embodiment, the gNB constructs a dataset D_{g} that includes samples as [symbol] xᵢ,z [symbol] where zᵢ is the output of the encoder part of the gNB model, e.g., zᵢ= [symbol] (xᵢ). The gNB can feed back: a) the complete D_{g} to each UE; orb) only transmit zᵢ's which are related to the xᵢ's that the gNB received form each particular UE. The communication overhead is less in the second alternative, but transmission of the complete D_{g} results in having a training data with a better generalization capability. The UE then uses the received data to train and/or update the UE part of the two-sided model, e.g., [symbol] .

Although the UE first method and the gNB first method may work, they may require high communication overhead and induce high latency. In various embodiments, there may be a lower communication cost than the UE first method and the gNB first method described above.

In certain embodiments, there may be a two-sided model where each UE transmits its feedback data zᵢ (e.g., constructed using the collected CSI information xᵢ and [symbol] and where i refers to different samples) to the gNB. The gNB uses this data and the [symbol] to generate the CSI data.

In another embodiment of UE first training, a UE uses a CSI dataset collected from an environment to train a local copy of the two sided model (e.g., both the UE part ( [symbol] ) and the gNB part ( [symbol] )). Afterwards, the gNB part of the model which is trained at the UE (or multiple UEs), [symbol] , is transmitted to the gNB. If needed to reduce communication overhead, [symbol] can be trained to have a low-resolution NN weights.

In the UE first training scheme, the gNB may receive a set of (zᵢ, oᵢ) to train the model.

In some embodiments, the UE may transmit its [symbol] to the gNB and then only transmits a set of zᵢ to the gNB. The gNB then can use [symbol] to locally have an estimate of oᵢ. It can then use [symbol] zᵢ, [symbol] (zᵢ) [symbol] to construct the training information needed for training of the gNB part of the two-sided model, e.g., [symbol] . It should be noted that since oᵢ is not a quantized representation, its transmission might lead to higher overhead in communication system compared to transmission of [symbol] .

For model monitoring and model update, it may be assumed that there is one trained version of [symbol] and [symbol] available and running at the UE and the gNB, respectively. In this scheme, [symbol] is trained to imitate [symbol] . Therefore, as the UE has both [symbol] and [symbol] , it can locally perform model monitoring regularly. For example, it can compute a dis-similarity metric between the desired output and the estimate of the gNB output (e.g., using [symbol] instead of [symbol] ). For instance, it can use E{∥oᵢ- [symbol] ( [symbol] (xᵢ))∥²}. If the dis-similarity becomes larger than a threshold, it can initiate an update procedure or it can send a signal to the gNB stating the need to update the model.

After initiation of the update procedure, as the UE has access to the newly collected CSI data, e.g., xᵢ, oᵢ, it can use them along the initial training data to update the local model, [symbol] and [symbol] . After the model update at the UE, it can send additional training data to the gNB, e.g., a set of [symbol] [symbol] (xᵢ), oᵢ [symbol] generated using the updated models. Alternatively, it can only send the updated [symbol] along with feedback of the newly collected CSI zᵢ. This enables the gNB to construct oᵢ without direct transmission of it, i.e., oᵢ≈ [symbol] (zᵢ). The resulted dataset can be used to update [symbol] at the gNB. It should be noted that not requiring to transmit oᵢ (e.g., due to its possible high communication overhead) may be more important during the update phase compared to the initial training phase.

In another embodiment of a gNB first training, the gNB first trains a local copy of the two-sided model, e.g., both the UE part ( [symbol] ) and the gNB part ( [symbol] ). The gNB part of the model, which is trained at the gNB, [symbol] , is transmitted to the UE. If needed to reduce communication overhead, [symbol] can be trained to have low-resolution NN weights.

For initial training in the gNB first scheme, to train [symbol] the UE needs to receive a set of zᵢ (e.g., corresponding to the xᵢ's the UE has previously sent to the gNB) or a new set of [symbol] xᵢ, zᵢ [symbol] .

In certain embodiments, the gNB may transmit its [symbol] to the UE without the need to transmit zᵢ. In fact, having [symbol] , the UE can train [symbol] by constructing a local two-sided model as [symbol] - [symbol] where it keeps the weights of [symbol] as fixed values and only trains for [symbol] using the CSI data collected from at the UE, e.g., xᵢ. For model monitoring and model update, it may be assumed that there is one trained version of [symbol] and [symbol] available and running at the UE and the gNB, respectively. As the UE has both [symbol] and [symbol] , it can perform model monitoring regularly. For example, it can compute a dis-similarity metric between the desired output and the output of the model exists at the gNB using for instance, it can use E{∥oᵢ- [symbol] ( [symbol] (xᵢ))∥²}. If the dis-similarity becomes larger than a threshold, it can initiate the update procedure or it can send a signal to the gNB stating the need to update the model.

In some embodiments for initiation of the update procedure, the UE may first try to update its encoder network [symbol] and check if it can solve the dis-similarity issue. For that, it can construct a locally two-sided model as [symbol] - [symbol] where it keeps the weights of [symbol] as fixed values and only train for [symbol] using the CSI data collected from at the UE, e.g., xᵢ. if successful, the UE uses the new [symbol] while the gNB uses the original [symbol] . If the local update of [symbol] fails to improve the performance, the UE sends new training data to the gNB to start gNB first training or it can switch to UE first training for updating the model.

In various embodiments there may be transmission of [symbol] where the UE part of the model, which is trained at the gNB, [symbol] , is transmitted to the UE. It should be noted that, if needed, to reduce communication overhead, [symbol] can be trained to have low-resolution NN weights.

In the gNB first scheme, to train [symbol] the UE needs to receive a set of zᵢ (e.g., corresponding to the xᵢ's the UE has previously sent to the gNB) or a new set of (xᵢ, zᵢ).

In certain embodiments, the gNB may transmit its [symbol] to the UE without the need to transmit zᵢ. In fact, having [symbol] , after collecting CSI information (xᵢ) the UE can itself generate zᵢ, i.e., zᵢ= [symbol] (xᵢ). The resulted [symbol] xᵢ, zᵢ [symbol] dataset can be used to train [symbol] .

In various embodiments, for a model update it may be assumed that there is one trained version of [symbol] and [symbol] available and running at the UE and the gNB, respectively. If a model update is needed, the gNB can first instruct the UEs to send new training data [symbol] xᵢ, oᵢ [symbol] so it [symbol] can update [symbol] and [symbol] . Having the new [symbol] , the gNB can send the new [symbol] to the UE so it can itself generate zᵢ, i.e., zᵢ= [symbol] (xᵢ) and then use the resulting [symbol] xᵢ, zᵢ [symbol] dataset to train [symbol] . It should be noted that the overhead of feeding back the [symbol] might be less than feeding back zᵢ for all xᵢ's and it may also be used on newly observed xᵢ to results in a model with better generalization capability.

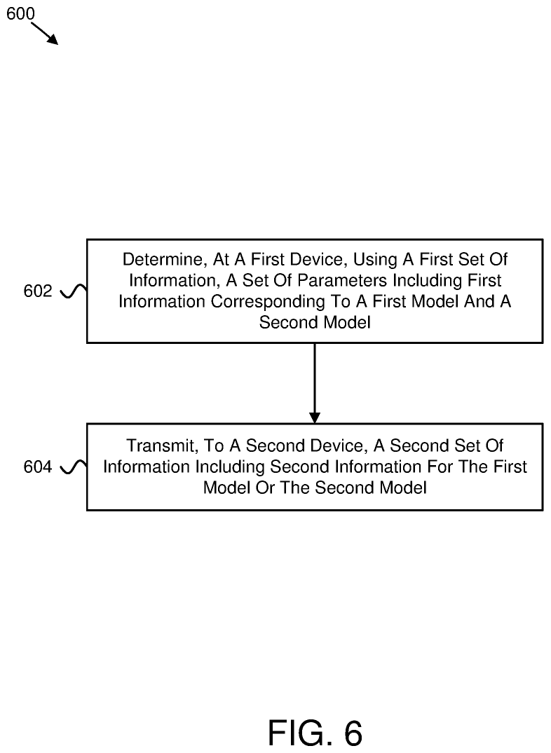

FIG. 6 is a flow chart diagram illustrating one embodiment of a method 600 for determining parameters for multiple models. In some embodiments, the method 600 is performed by an apparatus, such as the remote unit 102 and/or the network unit 104. In certain embodiments, the method 600 may be performed by a processor executing program code, for example, a microcontroller, a microprocessor, a CPU, a GPU, an auxiliary processing unit, a FPGA, or the like.

In various embodiments, the method 600 includes determining 602, at a first device, using a first set of information, a set of parameters including first information corresponding to a first model and a second model. In some embodiments, the method 600 includes transmitting 604, to a second device, a second set of information including second information for the first model or the second model.

In certain embodiments, the first device comprises a UE and the second device comprises a network device. In some embodiments, the first set of information comprises an input data and an expected output data of a two-part model. In various embodiments, the input data and the expected output data are related to channel state information.

In one embodiment, the first model and the second model are used for determining a latent representation of the input data and for generating the expected output data based on the latent representation. In certain embodiments, the second set of information comprises characterizing information for the second model. In some embodiments, the method 600 further comprises determining a first data based on the first model and input channel data.

In various embodiments, a representation of the first data is transmitted to the second device. In one embodiment, the method 600 further comprises determining whether to update the set of parameters based on the first model, the second model, or a combination thereof. In certain embodiments, the method 600 further comprises transmitting an update request to the second device.

In some embodiments, the method 600 further comprises determining an updated set of parameters based on a third set of information, wherein the third set of information comprises input data and expected output data of a two-part model. In various embodiments, the method 600 further comprises transmitting an update to the second set of information based on the updated set of parameters. In one embodiment, the first device comprises a network device and the second device comprises a UE.

In certain embodiments, the first set of information is received from the second device. In some embodiments, the first set of information comprises input data and expected output data of a two-part model. In various embodiments, the first model and the second model are used for determining a latent representation of the input data and generating the expected output data based on the latent representation.

In one embodiment, the second set of information comprises characterizing information for the second model. In certain embodiments, the second set of information comprises characterizing information for the first model.

In some embodiments, the network device comprises a next gNB. In various embodiments, the first model and the second model comprise a finite-bit weight resolution.

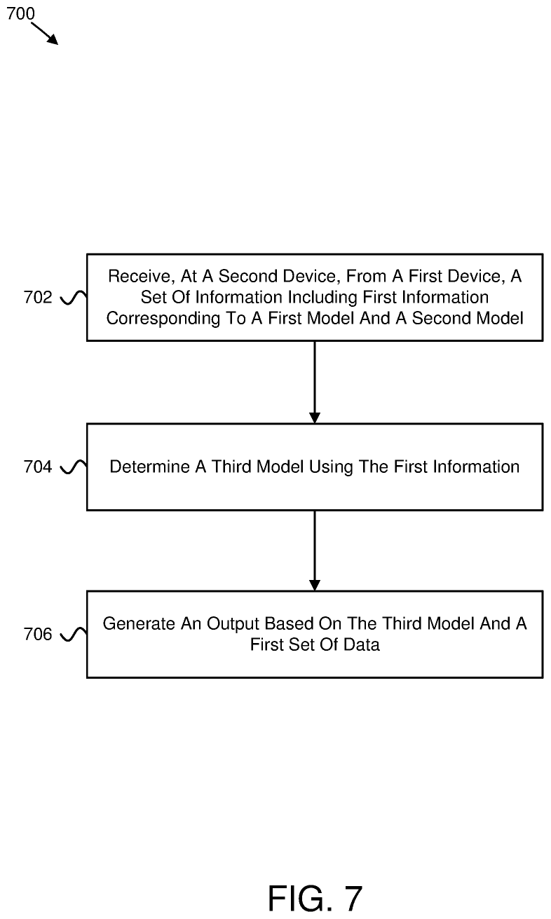

FIG. 7 is a flow chart diagram illustrating another embodiment of a method 700 for determining parameters for multiple models. In some embodiments, the method 700 is performed by an apparatus, such as the remote unit 102 and/or the network unit 104. In certain embodiments, the method 700 may be performed by a processor executing program code, for example, a microcontroller, a microprocessor, a CPU, a GPU, an auxiliary processing unit, a FPGA, or the like.

In various embodiments, the method 700 includes receiving 702, at a second device, from a first device, a set of information including first information corresponding to a first model and a second model. In some embodiments, the method 700 includes determining 704 a third model using the first information. In certain embodiments, the method 700 includes generating 706 an output based on the third model and a first set of data.

In certain embodiments, the first device comprises a UE and the second device comprises a network device. In some embodiments, the first set of data is received from the first device. In various embodiments, the output is determined based on the third model.

In one embodiment, the first model and the second model are used for determining a latent representation of input data and generating expected output data based on the latent representation. In certain embodiments, the set of information comprises characterizing information for the second model. In some embodiments, the second set of information comprises characterizing information for the first model.

In various embodiments, the first device comprises a network device and the second device comprises a UE. In one embodiment, the first set of data is based on channel data. In certain embodiments, the method 700 further comprises transmitting the output to the first device.

In some embodiments, the first model and the second model are used for determining a latent representation of input data and generating expected output data based on the latent representation. In various embodiments, the set of information comprises characterizing information for the second model. In one embodiment, the method 700 further comprises determining whether to update the set of parameters based on the third model and the set of first information.

In certain embodiments, the method 700 further comprises sending an update request to the first device. In some embodiments, the method 700 further comprises receiving an update request from the first device. In various embodiments, the method 700 further comprises sending a second set of data to the first device, wherein the second set of data is based on channel data.

In one embodiment, the method 700 further comprises receiving updated set of information from the first device. In certain embodiments, the set of information comprises characterizing information for the first model. In some embodiments, the network device comprises a next gNB.

In various embodiments, determining the third model comprises initial training of a set of NN parameters of the third model. In one embodiment, determining the third model comprises updating a set of NN parameters of the third model.

In one embodiment, an apparatus for wireless communication, the apparatus comprises: a processor; and a memory coupled to the processor, the processor configured to cause the apparatus to: determine, using a first set of information, a set of parameters including first information corresponding to a first model and a second model; and transmit, to a second device, a second set of information comprising second information for the first model or the second model.

In certain embodiments, the apparatus comprises a UE and the second device comprises a network device.

In some embodiments, the first set of information comprises an input data and an expected output data of a two-part model.

In various embodiments, the input data and the expected output data are related to channel state information.

In one embodiment, the first model and the second model are used for determining a latent representation of the input data and for generating the expected output data based on the latent representation.

In certain embodiments, the second set of information comprises characterizing information for the second model.

In some embodiments, the processor is further configured to cause the apparatus to determine a first data based on the first model and input channel data.

In various embodiments, a representation of the first data is transmitted to the second device.

In one embodiment, the processor is further configured to cause the apparatus to determine whether to update the set of parameters based on the first model, the second model, or a combination thereof.

In certain embodiments, the processor is further configured to cause the apparatus to transmit an update request to the second device.

In some embodiments, the processor is further configured to cause the apparatus to determine an updated set of parameters based on a third set of information, and the third set of information comprises input data and expected output data of a two-part model.

In various embodiments, the processor is further configured to cause the apparatus to transmit an update to the second set of information based on the updated set of parameters.

In one embodiment, the apparatus comprises a network device and the second device comprises a UE.

In certain embodiments, the first set of information is received from the second device.

In some embodiments, the first set of information comprises input data and expected output data of a two-part model.

In various embodiments, the first model and the second model are used for determining a latent representation of the input data and generating the expected output data based on the latent representation.

In one embodiment, the second set of information comprises characterizing information for the second model.

In certain embodiments, the second set of information comprises characterizing information for the first model.

In some embodiments, the network device comprises a next gNB.

In various embodiments, the first model and the second model comprise a finite-bit weight resolution.

In one embodiment, a method at a first device for wireless communication, the method comprises: determining, using a first set of information, a set of parameters including first information corresponding to a first model and a second model; and transmitting, to a second device, a second set of information comprising second information for the first model or the second model.

In certain embodiments, the first device comprises a UE and the second device comprises a network device.

In some embodiments, the first set of information comprises an input data and an expected output data of a two-part model.

In various embodiments, the input data and the expected output data are related to channel state information.

In one embodiment, the first model and the second model are used for determining a latent representation of the input data and for generating the expected output data based on the latent representation.

In certain embodiments, the second set of information comprises characterizing information for the second model.

In some embodiments, the method further comprises determining a first data based on the first model and input channel data.

In various embodiments, a representation of the first data is transmitted to the second device.

In one embodiment, the method further comprises determining whether to update the set of parameters based on the first model, the second model, or a combination thereof.

In certain embodiments, the method further comprises transmitting an update request to the second device.

In some embodiments, the method further comprises determining an updated set of parameters based on a third set of information, wherein the third set of information comprises input data and expected output data of a two-part model.

In various embodiments, the method further comprises transmitting an update to the second set of information based on the updated set of parameters.

In one embodiment, the first device comprises a network device and the second device comprises a UE.

In certain embodiments, the first set of information is received from the second device.

In some embodiments, the first set of information comprises input data and expected output data of a two-part model.

In various embodiments, the first model and the second model are used for determining a latent representation of the input data and generating the expected output data based on the latent representation.

In one embodiment, the second set of information comprises characterizing information for the second model.

In certain embodiments, the second set of information comprises characterizing information for the first model.

In some embodiments, the network device comprises a next gNB.

In various embodiments, the first model and the second model comprise a finite-bit weight resolution.

In one embodiment, an apparatus for wireless communication, the apparatus comprises: a processor; and a memory coupled to the processor, the processor configured to cause the apparatus to: receive, from a first device, a set of information comprising first information corresponding to a first model and a second model; determine a third model using the first information; and generate an output based on the third model and a first set of data.

In certain embodiments, the first device comprises a UE and the apparatus comprises a network device.

In some embodiments, the first set of data is received from the first device.

In various embodiments, the output is determined based on the third model.

In one embodiment, the first model and the second model are used for determining a latent representation of input data and generating expected output data based on the latent representation.

In certain embodiments, the set of information comprises characterizing information for the second model.

In some embodiments, the second set of information comprises characterizing information for the first model.

In various embodiments, the first device comprises a network device and the apparatus comprises a UE.

In one embodiment, the first set of data is based on channel data.

In certain embodiments, the processor is further configured to cause the apparatus to transmit the output to the first device.

In some embodiments, the first model and the second model are used for determining a latent representation of input data and generating expected output data based on the latent representation.

In various embodiments, the set of information comprises characterizing information for the second model.

In one embodiment, the processor is further configured to cause the apparatus to determine whether to update the set of parameters based on the third model and the set of first information.

In certain embodiments, the processor is further configured to cause the apparatus to send an update request to the first device.

In some embodiments, the processor is further configured to cause the apparatus to receive an update request from the first device.

In various embodiments, the processor is further configured to cause the apparatus to send a second set of data to the first device, wherein the second set of data is based on channel data.

In one embodiment, the processor is further configured to cause the apparatus to receive updated set of information from the first device

In certain embodiments, the set of information comprises characterizing information for the first model.

In some embodiments, the network device comprises a next gNB.

In various embodiments, the processor is configured to cause the apparatus to determine the third model comprises the processor being further configured to cause the apparatus to initially train a set of NN parameters of the third model.

In one embodiment, the processor is configured to cause the apparatus to determine the third model comprises the processor being further configured to cause the apparatus to update a set of NN parameters of the third model.

In one embodiment, a method at a second device for wireless communication, the method comprises: receiving, from a first device, a set of information comprising first information corresponding to a first model and a second model; determining a third model using the first information; and generating an output based on the third model and a first set of data.

In certain embodiments, the first device comprises a UE and the second device comprises a network device.

In some embodiments, the first set of data is received from the first device.

In various embodiments, the output is determined based on the third model.

In one embodiment, the first model and the second model are used for determining a latent representation of input data and generating expected output data based on the latent representation.

In certain embodiments, the set of information comprises characterizing information for the second model.

In some embodiments, the second set of information comprises characterizing information for the first model.

In various embodiments, the first device comprises a network device and the second device comprises a UE.

In one embodiment, the first set of data is based on channel data.

In certain embodiments, the method further comprises transmitting the output to the first device.

In some embodiments, the first model and the second model are used for determining a latent representation of input data and generating expected output data based on the latent representation.

In various embodiments, the set of information comprises characterizing information for the second model.

In one embodiment, the method further comprises determining whether to update the set of parameters based on the third model and the set of first information.

In certain embodiments, the method further comprises sending an update request to the first device.

In some embodiments, the method further comprises receiving an update request from the first device.

In various embodiments, the method further comprises sending a second set of data to the first device, wherein the second set of data is based on channel data.

In one embodiment, the method further comprises receiving updated set of information from the first device.

In certain embodiments, the set of information comprises characterizing information for the first model.

In some embodiments, the network device comprises a next gNB.

In various embodiments, determining the third model comprises initial training of a set of NN parameters of the third model.

In one embodiment, determining the third model comprises updating a set of NN parameters of the third model.

Embodiments may be practiced in other specific forms. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

1. An apparatus for performing a network function, the apparatus comprising:
at least one memory; and
at least one processor coupled with the at least one memory and configured to cause the apparatus to:
determine, using a first set of information, a set of parameters comprising first information corresponding to a first model and a second model; and
transmit, to a second device, a second set of information comprising second information for the first model or the second model.

2. The apparatus of claim 1, wherein the second device comprises a user equipment (UE).

3. The apparatus of claim 2, wherein the first set of information comprises an input data and an expected output data of a two-part model.

4. The apparatus of claim 3, wherein the input data and the expected output data are related to channel state information.

5. The apparatus of claim 3, wherein the first model and the second model are used for determining a latent representation of the input data and for generating the expected output data based on the latent representation.

6. The apparatus of claim 2, wherein the second set of information comprises characterizing information for the second model.

7. (canceled)

8. (canceled)

9. The apparatus of claim 2, wherein the at least one processor is configured to cause the apparatus to determine whether to update the set of parameters based on the first model, the second model, or a combination thereof.

10. (canceled)

11. The apparatus of claim 9, wherein the at least one processor is configured to cause the apparatus to determine an updated set of parameters based on a third set of information, and the third set of information comprises input data and expected output data of a two-part model.

12. The apparatus of claim 11, wherein the at least one processor is configured to cause the apparatus to transmit an update to the second set of information based on the updated set of parameters.

13. The apparatus of claim 1, wherein the first set of information comprises input data and expected output data of a two-part model.

14. The apparatus of claim 13, wherein the first model and the second model are used for determining a latent representation of the input data and generating the expected output data based on the latent representation.

15. The apparatus of claim 1, wherein the second set of information comprises characterizing information for the first model.

16. A processor for wireless communication, comprising:
at least one controller coupled with at least one memory and configured to cause the processor to:
determine, using a first set of information, a set of parameters comprising first information corresponding to a first model and a second model; and
transmit, to a second device, a second set of information comprising second information for the first model or the second model.

17. A method performed by a network function, the method comprising:
determining, using a first set of information, a set of parameters comprising first information corresponding to a first model and a second model; and
transmitting, to a second device, a second set of information comprising second information for the first model or the second model.

18. An apparatus comprising a first device, the apparatus comprising:
at least one memory; and
at least one processor coupled with the at least one memory and configured to cause the apparatus to:
receive, from a second device, a set of information comprising first information corresponding to a first model or a second model;
determine a third model using the first information; and
generate an output based on the third model and a first set of data.

19. (canceled)

20. (canceled)

21. The apparatus of claim 18, wherein the second device comprises a network device.

22. The apparatus of claim 18, wherein the first set of data is related to channel state information

23. The apparatus of claim 18, wherein the first set of information comprises an input data and an expected output data of the second model.

24. The apparatus of claim 18, wherein the at least one processor is configured to cause the first device to transmit an update request to the second device.

25. The apparatus of claim 18, wherein the at least one processor is configured to cause the first device to determine an updated set of parameters of the third model based on a third set of information, wherein the third set of information comprises information related to the first model, the second model, or both.
